(19) United States
(12) Patent Application Publication
(10) Pub. No.: US 2024/0379932 A1
(43) Pub. Date: Nov. 14, 2024

(54) LASER PATTERNED SOLID-STATE BATTERIES, AND METHODS OF MAKING AND USING THE SAME

(71) Applicants: Khanh TRAN, San Jose, CA (US); Alex Yan, San Jose, CA (US); Arvind KAMATH, Los Altos, CA (US); Zhongchun WANG, San Jose, CA (US)

(72) Inventors: Khanh TRAN, San Jose, CA (US); Alex Yan, San Jose, CA (US); Arvind KAMATH, Los Altos, CA (US); Zhongchun WANG, San Jose, CA (US)

(73) Assignee: Ensurge Micropower ASA, Oslo (NO)

(21) Appl. No.: 18/640,416

(22) Filed: Apr. 19, 2024

Related U.S. Application Data
(60) Provisional application No. 63/500,627, filed on May 8, 2023.

(51) Int. Cl. H01M 4/04; H01M 4/76; H01M 10/0525; H01M 10/0562

(52) U.S. Cl. CPC H01M 4/0407; H01M 4/76; H01M 10/0525; H01M 10/0562

(57) ABSTRACT

A method of making a lithium metal oxide film is disclosed. The method includes blanket-depositing a cathode material, a solid-state electrolyte, and an anode current collector (ACC) material on a substrate, laser-patterning the ACC material to define the solid-state battery cells and form an ACC in each of the cells, and cutting or dicing the solid-state battery cells through the electrolyte and the cathode material to form a cathode in each of the solid-state battery cells. The method avoids issues related to topography and wet patterning when making the cathode, electrolyte and ACC layers. The method also avoids the need to fabricate a physical mask, thereby enabling greater patterning flexibility, higher throughput and lower costs than photolithography.

### CROSS-REFERENCE TO RELATED APPLICATIONS

This application claims the benefit of U.S. Provisional Pat. Appl. No. 63/500,627, filed May 8, 2023, pending, incorporated herein by reference in its entirety.

### FIELD OF THE INVENTION

The present invention generally relates to the field of solid-state and/or thin film batteries. More specifically, embodiments of the present invention pertain to solid-state batteries containing one or more laser-patterned layers, and methods of making and using the same.

### DISCUSSION OF THE BACKGROUND

Solid-state lithium batteries are ionic-charge storage devices that are ideally suited for wearable, IoT, and other applications due to their small size, safety, and high cyclability. In an “anode-less” architecture, a solid-state lithium battery is a multi-layer structure consisting of a cathode current collector (CCC), a cathode, a solid-state electrolyte, and an anode current collector (ACC). While the ACC is electrically separated from the CCC by the solid-state electrolyte, it usually has a smaller area or pattern than the CCC to avoid ACC-to-CCC shorting when cells are cut from a larger substrate (e.g., a roll or sheet).

One way to form the ACC is to blanket-deposit a film, then pattern it using photolithography and etching. Besides the multiple steps required to achieve the patterning result, this scheme typically includes wet processing, which should generally be avoided when making solid-state batteries, to avoid material impacts to the cathode and solid-state electrolyte films. Another way is to deposit the ACC through a shadow mask, to achieve the pattern directly. However, if the shadow mask is physically not in good contact with the device surface, the ACC deposition can creep under the mask opening edges, resulting in poor pattern fidelity.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to solid-state and thin film batteries, and more specifically to a solid-state battery and methods of making and using the same. The present invention avoids the issues in the background art by patterning a blanket ACC film by laser patterning and/or laser ablation. Besides achieving a dry and high-fidelity pattern, this approach is also advantageous for patterning flexibility, lower cost, and higher throughput, since the laser ablation pattern and process does not involve fabricating a physical mask (e.g., a photolithography or shadow mask).

Thus, in one aspect, the invention relates to a method of making solid-state battery cells, comprising blanket-depositing a cathode material, a solid-state electrolyte, and an anode current collector (ACC) material on a substrate; laser-patterning the ACC material to define the solid-state battery cells and form an ACC in each of the cells; and cutting or dicing the solid-state battery cells through the electrolyte and the cathode material to form a cathode in each of the solid-state battery cells. The method may further comprise cleaning the laser-patterned battery cells prior to cutting or dicing the battery cells, encapsulating each of the battery cells with an encapsulant (after cutting or dicing the battery cells), singulating the (encapsulated) battery cells, and/or packaging the singulated battery cells. The method may also further comprise stacking the singulated battery cells prior to packaging the cells.

In some embodiments of the method, the ACC material is laser-patterned using a programmable laser patterning device. In such embodiments, the method may further comprise programming the programmable laser patterning device. For example, the programmable laser patterning device may be programmed to form polylines in the ACC material. The polylines may comprise a first plurality of parallel lines along a first direction and a second plurality of parallel lines along a second direction. The first and second pluralities of parallel lines may not form sharp corners. For example, the second direction may be orthogonal to the first direction. In other or further examples, the first and second pluralities of parallel lines may have a width of 2-50 μm, independent of each other (individually or as one of the pluralities, in which each of the first plurality of parallel lines has a first width, and each of the second plurality of parallel lines has a second width independent of the first width).

In various embodiments, the ACC material is laser-patterned using light having a wavelength of 240-1400 nm, a pulse length of 5 femtoseconds to 1000 ns, a pulse frequency of 105-1014 Hz, and/or a power of 10-1000 W.

Some embodiments of the method may further comprise forming a moat in each of the laser-patterned battery cells prior to cutting or dicing the battery cells. The moat may be formed by forming a groove in a peripheral region of each of the laser-patterned battery cells. The groove may pass through the solid-state electrolyte, and pass through (or at least into) the cathode. The peripheral region is generally the outermost 5-20% of the laser-patterned battery cell, either by length and/or width, or by area. The groove may have a width of 3-20 μm. The groove may be formed by laser ablation, mechanical dicing, or low-resolution photolithographic patterning.

In some embodiments of the method, cutting or dicing the battery cells comprises cutting or dicing the battery cells through the substrate every other cell to form ACC edges or sidewalls of the battery cells. In such embodiments, cutting or dicing the battery cells may form dual cells or dual rows or columns of cells.

Embodiments of the method that include encapsulating each of the battery cells may form or deposit the encapsulant along the ACC edges or sidewalls of the cells, and may also form (or leave) an opening in the encapsulant exposing the ACC. In some embodiments, encapsulating each of the battery cells comprises inkjet printing or screen printing the encapsulant onto the battery cells in a pattern including the opening. In other embodiments, encapsulating each of the laser-patterned battery cells may comprise coating or blanket-depositing the encapsulant onto the battery cells, and patterning the coated or blanket-deposited encapsulant to form the opening.

Typically, the encapsulant comprises a moisture barrier and/or electrical insulation film. For example, the encapsulant may comprise a polyolefin (which may be moisture-repellant or moisture-resistant).

In some embodiments, the method further comprises forming a redistribution layer on the ACC and, when present, the encapsulant. When the encapsulant is present, the redistribution layer is formed on the ACC exposed through the opening, and when the encapsulant is along the ACC edge or sidewall, the redistribution layer may also be formed on the encapsulant along the ACC edge or sidewall. In some embodiments, the redistribution layer comprises an elemental metal or an alloy thereof (e.g., an alloy consisting essentially of elemental metals). In various embodiments, the redistribution layer is formed by sputtering, atomic layer deposition (ALD) or thermal evaporation, followed by photolithographic patterning and etching. Alternatively, the redistribution layer may be formed by selective deposition, such as inkjet printing, aerosol-jet printing or screen printing. In certain embodiments, the redistribution layer has a thickness of 0.25-2.0 μm.

In some embodiments of the method, singulating the encapsulated battery cells comprises laser dicing, mechanical dicing or stamping. For example, singulating the encapsulated battery cells may comprise cutting or dicing the dual cells or dual rows or columns of cells through the substrate to form CCC edges or sidewalls of the battery cells. In further embodiments, the method may further comprise stacking and/or packaging the singulated battery cells. The singulated battery cells may comprise singulated rows or columns of the battery cells. In some embodiments, singulating the encapsulated battery cells forms CCC edges or sidewalls of the battery cells. The stacked battery cells may have all of the ACC edges or sidewalls on a first side of the stacked battery cells, and all of the CCC edges or sidewalls on a second side of the stacked battery cells.

In some embodiments, stacking the singulated battery cells comprises depositing an adhesive (e.g., an epoxy adhesive) on a first one of the singulated battery cells, and placing a next one of the singulated battery cells on the first one of the singulated battery cells. Optionally, the method may further comprise stacking one or more of the singulated battery cells on the next one of the singulated battery cells until a last one of the singulated battery cells is stacked. In other or further embodiments, stacking the singulated battery cells further comprises placing a dummy cell on the last one of the singulated battery cells.

In various embodiments, placing the next one of the singulated battery cells on the first one of the singulated battery cells comprises a pick-and-place operation. In other embodiments, when the singulated battery cells comprise a row or column of cells, stacking the singulated battery cells may comprise strip folding or strip stacking the row or column of cells.

In some embodiments, the cathode material comprises a lithium metal oxide or lithium metal phosphate, such as lithium cobalt oxide (LCO), lithium manganese oxide (LMO), or lithium iron phosphate (LFP). In other or further embodiments, blanket-depositing the cathode material may comprise laser deposition, sputtering, chemical vapor deposition (CVD), sol-gel processing, screen printing, inkjet printing, spray coating, or extrusion coating.

In some embodiments, the solid-state electrolyte comprises lithium phosphorus oxynitride (LiPON), carbon-doped LiPON, or Li₂WO₄. In other or further embodiments, blanket-depositing the solid-state electrolyte comprises depositing a LiPON layer or a tungsten oxide layer of the formula WO₃₊ₓ(0≤x≤1) by sputtering or atomic layer deposition (ALD). When blanket-depositing the solid-state electrolyte comprises depositing the tungsten oxide layer, blanket-depositing the solid-state electrolyte may comprise sputtering using a metallic or elemental tungsten target in an oxygen-containing atmosphere to form the tungsten oxide layer, then lithiating and thermally annealing the tungsten oxide layer. In some embodiments, the method further comprises forming an interface material comprising a lithiated metal oxide on the cathode material and/or the solid-state electrolyte.

In some embodiments, the ACC material comprises a conductive metal, such as nickel, zinc, copper, tungsten, or an alloy thereof, or graphite. When the ACC material is the conductive metal, the conductive metal is incapable of forming an alloy with lithium. The ACC material may be deposited by spray coating, sputtering, evaporation, CVD or ALD, and may have a thickness of 0.1-5 μm.

In some embodiments, the substrate comprises a metal foil. For example, the metal foil may function as a cathode current collector in each of the battery cells. In such embodiments, the method may further comprise forming a diffusion barrier on one or both major surfaces of the metal foil prior to blanket-depositing the cathode material. In various examples, the metal foil comprises elemental aluminum, copper, titanium, nickel, iron, or an alloy thereof (e.g., stainless steel). For example, the metal foil may have a thickness of 10-100 μm. In embodiments including the diffusion barrier, the method may further comprise depositing an insulation layer such as a silicon oxide on the diffusion barrier. Thus, in some embodiments, the diffusion barrier may comprise a metal nitride or a combination of the metal nitride and a silicon oxide (e.g., alternating diffusion barrier and insulation layers).

In another aspect, the invention relates to a solid-state battery cell, comprising a cathode, a solid-state electrolyte, and a laser-patterned anode current collector (ACC) on a substrate. The electrolyte and the cathode are co-extensive (i.e., have the same width, the same length, and aligned sidewalls). The laser-patterned ACC has peripheral edges or sidewalls with a greater variance (e.g., from planarity) than a photolithographically-patterned ACC having otherwise identical properties and characteristics, and sharper uppermost edges (i.e., the angles between the major surface away from the electrolyte and the sidewalls), greater purity and/or better electrical properties than a printed ACC having otherwise identical properties and characteristics. The present solid-state battery cell may further comprise any of the other structures and materials described herein.

Other capabilities and advantages of the present invention will become readily apparent from the detailed description of various embodiments below.

### BRIEF DESCRIPTION OF THE DRAWINGS

FIGS. 1-10 are cross-sectional views of various structures in an exemplary method of manufacturing solid-state battery cells, according to embodiments of the present invention.

FIG. 11 is a side view of multiple battery cells of FIG. 10 in a stack, according to embodiments of the present invention.

FIG. 12 is a perspective view of an exemplary packaged battery according to one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention concerns a solid-state battery containing a printed encapsulation and/or redistribution layer and methods of making the same. The present solid-state battery includes, in some embodiments, an intrinsic anode-less battery comprising a substrate (which can also serve or function as a cathode current collector [CCC]), a cathode or cathode layer, a solid-state electrolyte (SSE) or solid-state electrolyte layer, and an anode current collector (ACC). In anode-less embodiments, no lithium anode is formed between the SSE and the ACC during manufacturing. A lithium anode may form during or upon completion of a battery charging operation.

The following discussion provides an example of a manufacturing process for solid-state batteries and stacked solid-state batteries, as well as variations of the process.

### An Exemplary Method of Making a Solid-State Battery

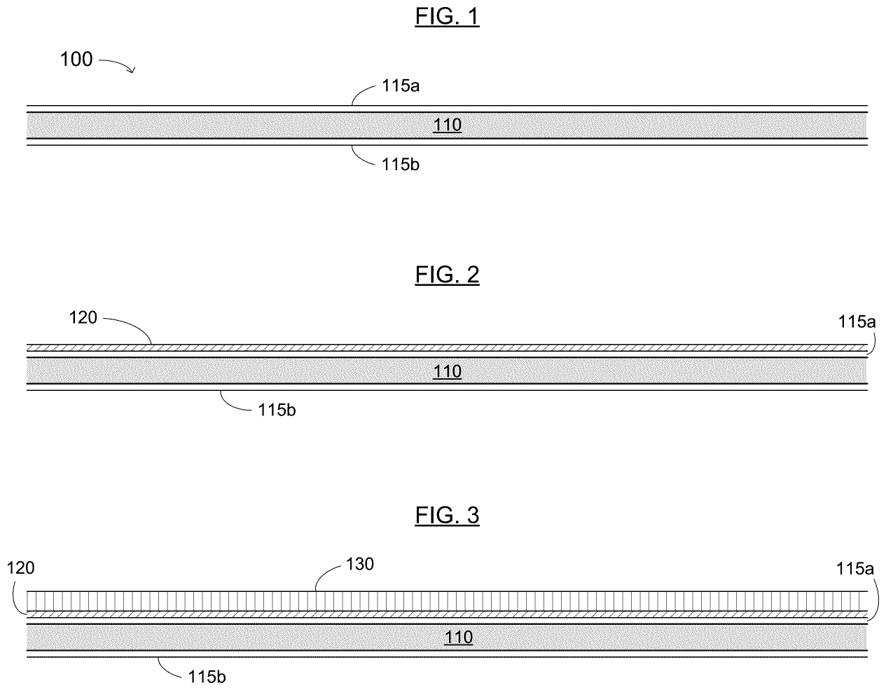

FIGS. 1-10 show certain structures in an exemplary method of making a solid-state battery. FIG. 1 shows a substrate 100, comprising a metal foil, sheet or film 110 and optional first and second barriers 115a-b on opposite major surfaces of the metal foil, sheet or film 110. When the foil, sheet or film 110 is a metal foil, the first and second barriers 115a-b are not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the sheet or film can also be a metal sheet or metal roll. For example, the sheet or film may be 10-100 μm thick, whereas a metal sheet may have a thickness of >100 μm, up to about 1-2 mm, although the invention is not so limited. Other alternative substrates include a metal coating on a mechanical substrate, such as aluminum, copper, nickel, titanium, etc., on a removable plastic film, sheet or roll.

The barrier 115a-b comprises one or more layers of one or more materials in a thickness effective to prevent migration of atoms or ions from the metal foil, sheet or film 110 into overlying layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, titanium tungsten nitride, TiW alloy, tantalum nitride, etc. In some embodiments, each of the first and second barriers 115a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 115a or 115b may have a total thickness of 0.05-3 μm, but the barrier 115 is not limited to this range. The barriers 115a-b may be blanket-deposited onto the foil, sheet or film 110 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. No. 9,299,845 and U.S. patent application Ser. No. 16/659,871, filed Oct. 22, 2019 (Atty. Docket No. IDR5090), the relevant portions of each of which are incorporated by reference herein.

In some embodiments, the foil, sheet or film 110 functions as a cathode current collector. In such embodiments, at least the barrier 115a (and optionally the barrier 115b) is a conductive, amorphous material, such as the refractory metal nitrides listed above or an amorphous metal alloy (e.g., a TiW alloy).

FIG. 2 shows the metal substrate 100 with a cathode 120 thereon. The cathode 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 120 may be blanket deposited by laser deposition (e.g., pulsed laser deposition or PLD), sputtering, chemical vapor deposition (CVD), sol-gel processing, etc. Alternatively, the cathode 120 may be selectively deposited by screen printing, inkjet printing, spray coating, or extrusion coating (e.g., using an ink comprising one or more sol-gel precursors and one or more solvents, having a viscosity appropriate for the printing or coating technique).

FIG. 3 shows a solid-state electrolyte 130 on the cathode 120. The electrolyte 130 may comprise or consist essentially of a conventional lithium phosphorus oxynitride (LiPON, which may optionally be carbon-doped) or Li₂WO₄, a good Li-ion conductor. In some embodiments, the electrolyte 130 may further comprise optional cathode and/or anode interface layers (not shown), each of which may comprise a lithiated metal oxide (see, e.g., U.S. patent application Ser. No. 17/185,111, filed Feb. 25, 2021, the relevant portions of which are incorporated hercin by reference). For example, a metal oxide (e.g., NbO₂, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). Alternatively or additionally, an amorphous (e.g., elemental silicon) interlayer may be deposited on the electrolyte 130 prior to formation of the anode current collector 140 to inhibit reduction of the electrolyte 130. In some embodiments, thermal annealing can modify the interface(s) between the layers of the cell, which can significantly reduce charge transfer resistance.

Forming the electrolyte 130 may comprise depositing a LiPON layer or a tungsten oxide layer of the formula WO₃₊ₓ(0≤x≤1) by sputtering, optionally using pulsed DC power. When the electrolyte 130 comprises LiPON, it may be deposited by RF sputtering or ALD. The sputtering target may comprise a Li₃PO₄ or mixed graphite-Li₃PO₄target, the latter of which may contain 1-15 wt % of graphite, when the electrolyte 130 comprises LiPON or carbon-doped LiPON, and a metallic/elemental tungsten target when the electrolyte 130 comprises a tungsten oxide. In the latter case, sputtering is performed in an oxygen or oxygen-containing atmosphere. The method of making the electrolyte 130 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (c.g., sputtering or thermally evaporating elemental lithium onto the tungsten oxide in a vacuum chamber, optionally while heating the substrate 100). Thermal annealing may comprise heating at a temperature of 150-500°° C. for a length of time of 5-240 minutes, or any temperature or length of time therein (c.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

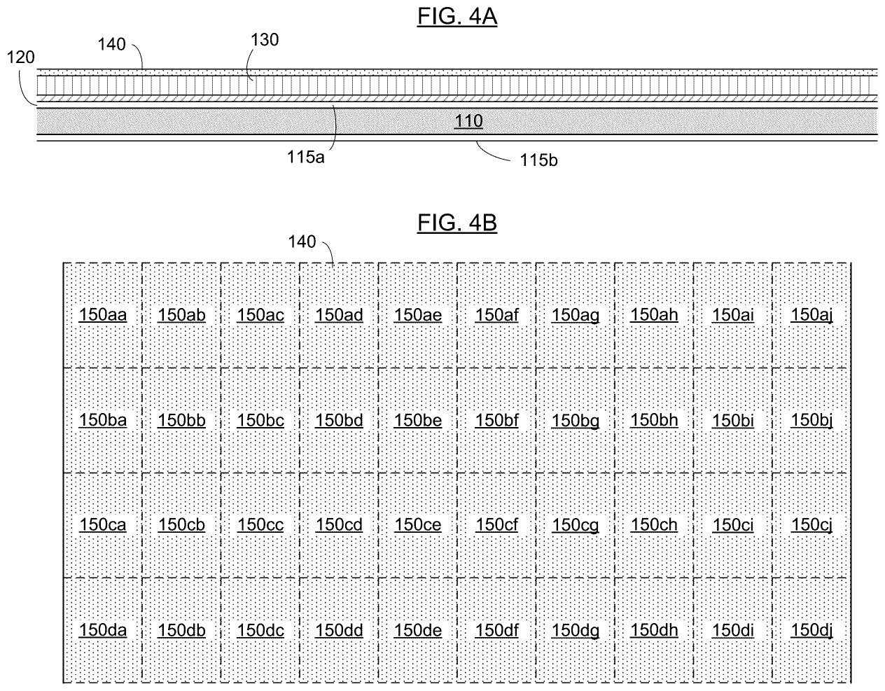

FIG. 4A shows an anode current collector (ACC) layer 140 blanket-deposited on the electrolyte 130. A separately-formed anode is not necessary in solid-state lithium batteries, as a lithium anode can be formed between the electrolyte 130 and the anode current collectors formed from layer 140 during charging, if necessary. Optionally, however, a thin lithium anode can be deposited by evaporation onto the electrolyte 130 prior to formation of the anode current collector layer 140. Alternatively, a thin silicon seed layer may be blanket-deposited onto the electrolyte 130 prior to deposition of the ACC layer 140. The silicon seed layer may be deposited by chemical vapor deposition (CVD; e.g., from silane gas), atomic layer deposition (ALD), coating from a liquid-phase silane such as trisilane, tetrasilane, cyclopentasilane, etc. The silicon seed layer may have a thickness of from 20 to 500 Å or any thickness or range of thicknesses therein (e.g., 50-200 Å).

The anode current collector layer 140 generally comprises a conductive metal, such as nickel, zinc, copper, tungsten, alloys thereof (e.g., NiTi, NiV), etc., or another conductor, such as graphite. Preferably, the conductive metal for the anode current collector layer 140 is incapable of forming an alloy with lithium (e.g., a non-Li alloying metal or alloy). The anode current collector layer 140 can be deposited by spray coating or other blanket deposition technique (e.g., sputtering, evaporation, chemical vapor deposition [CVD] or atomic layer deposition [ALD]). The anode current collector layer 140 may have a thickness of 0.1-5 μm, although it is not limited to this range.

FIG. 4B shows a plan or top-down view of the battery layers 120, 120 and 140 on the barrier-protected substrate 110/115. Only the anode current collector layer 140 is visible. The substrate 110 may be a sheet or a roll (e.g., of a metal foil). Cell regions 150aa-150dj are shown in dashed lines. Fixed edges of the substrate 110 are shown as solid lines.

The battery may further include one or more interlayers that modify the interfaces between different functional layers. For example, a metal oxide (e.g., Nb₂O₅, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the anode current collector layer 140 to inhibit reduction of the electrolyte. Of course, the battery cell can be made in the reverse order (i.e., the anode current collector may be first formed on the substrate, then the remaining layers deposited in reverse order thereon).

An advantage of the present method is that all of the active battery layers (e.g., the cathode 120, the solid-state electrolyte 130 and the anode current collector 140) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers.

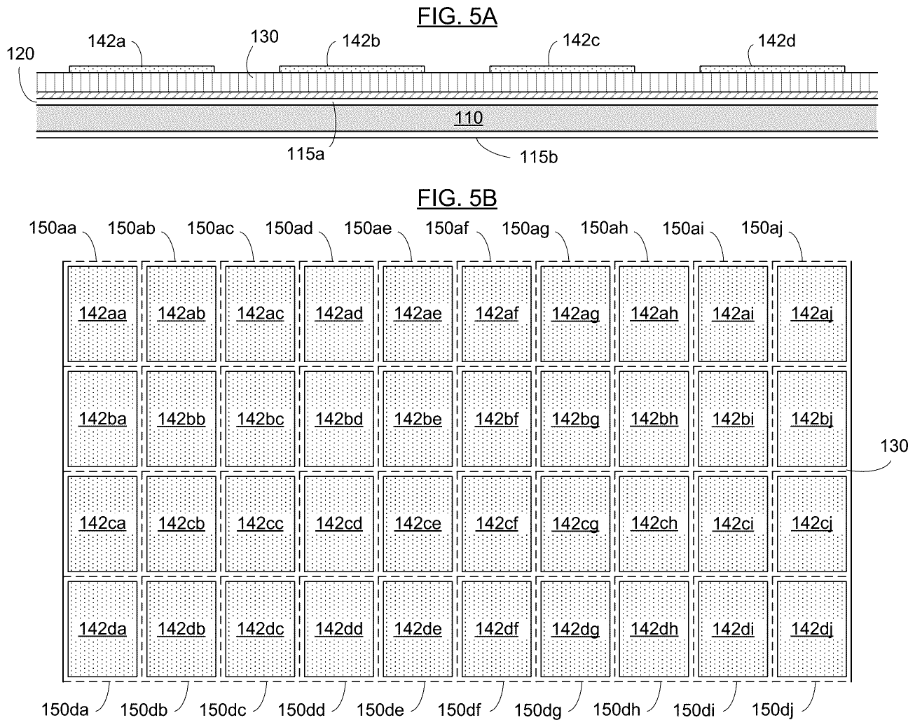

FIGS. 5A-B show the anode current collectors 142 after laser patterning and/or laser ablation. Typically, an ablation pattern (e.g., a graphical drawing representing the areas of the anode current collector layer 140 to be removed) is created and run on a programmable laser patterning device. The drawing may consist of a series of polylines (e.g., a first plurality of parallel lines spaced apart by a first distance, and a second plurality of parallel lines orthogonal to the first plurality of parallel lines, spaced apart by a second distance the same as or different from the first distance) at an optimized spacing to form cleanly ablated regions outside of the desired remaining pattern of ACCs (e.g., ACCs 142aa-dj in FIG. 5B).

In a representative example, the graphical drawing is in a format used by laser patterning or ablation tools, such as an Autocad.dxf or.dwg file. The graphical drawing comprises or consists of a series of polylines having a width that may be optimized for a given laser tool. In some embodiments, the polylines exclude sharp corners (e.g., angles between crossing, consecutive or adjacent lines that have an angle therebetween of 90° or less), to reduce or minimize electric field concentration at such corners, which may adversely affect battery cycling and/or battery lifetimes. Thus, laser patterning the anode current collectors 142 enables corner rounding of the anode current collectors 142 in each cell. Because there is no need for a mask, the ultimate shape of the anode current collectors 142 is somewhat arbitrary, and can be any shape that can be formed using a conventional laser patterning or laser ablation tool.

The laser beam profile is typically gaussian or top hat, depending on the target profile for material removal. The line widths may be in the range of 2-50 μm (or any width or range of widths therein, such as, e.g., 5-25 μm), depending on the laser beam spot size and energy profile. For example, the full width at half-maximum power (or half-power beam width) of the laser beam may be in the range of 2-50 μm, but it can be adjusted (increased or decreased) using focusing lenses.

The laser power and scan parameters may be optimized for a given laser wavelength and desired ablation depth. For example, the laser wavelength may range from infrared or red (e.g., 800-1400 nm) to ultraviolet (e.g., 240-400 nm), although the invention is not limited to such ranges. The pulse length of the laser can be nanosecond (e.g., 1-1000 ns, or any value or range of values therein), picosecond (e.g., 5-1000 ps, or any value or range of values therein), or femtosecond (e.g., 5-5000 femtoseconds, or any value or range of values therein), although the invention is not limited to such pulse length ranges. In working examples using an IR laser (e.g., wavelength in the range of 800-1400 nm), when the pulse length is in the femtosecond range, the pulse frequency may be in the range of 10⁹-10¹⁴ Hz (or any value or range of values therein), and when the pulse length is in the nanosecond range, the pulse frequency may be in the range of 10⁵-10⁹ Hz, or any value or range of values therein. In any case, the laser power may be in the range of 10-1000 W, or any value or range of values therein. However, the invention is not limited to such ranges or values, and can be easily extended to other frequencies, pulse lengths, and wavelengths. One skilled in the art is capable of determining laser parameters that provide selectivity for removal of the ACC material relative to the electrolyte material.

Referring to FIG. 5A (a cross-sectional view of the battery structure following laser patterning/ablation along at least one dimension of the substrate 110), ACCs 142a-d for cells in different columns on the substrate are shown. Substantially all of the ACC layer 140 between adjacent ACCs 142a-d is removed, but preferably, minimal electrolyte 130 is removed.

FIG. 5B is a plan or top-down view of the battery structure of FIG. 5A following laser patterning along two orthogonal dimensions (e.g., length and width) of the substrate 110. Cells 150aa-aj and 150da-dj are indicated, and ACCs 142aa-dj are separated from each other by gaps exposing the electrolyte layer 130.

After laser patterning/ablation, debris removal or cleaning (if needed) may comprise dry etching (e.g., using an etch chemistry and conditions that are at least somewhat selective for removal of the ACC material relative to the electrolyte material), a line beam laser (e.g., having a relatively small or narrow beam width), a high-velocity gas jet (e.g., a stream of dry CO₂, nitrogen or air), or by wet chemical cleaning (e.g., using distilled, deionized water, followed by an organic solvent such as acetone or isopropyl alcohol), optionally in the presence of applied ultrasound.

Advantages of laser patterning and/or ablation of the anode current collector layer 140 include the following:
Patterning is dry, so there is no effect on the battery layers or their chemistry.
The patterned edges of the ACCs 142aa-dj are sharp
Patterning throughput is typically higher than photolithography due to the relatively high laser scan rate
Lower cost, due to the elimination of lithography or shadow masks
Patterning flexibility is maximized, as laser ablation flows and/or is driven by a graphical drawing, which is easy and fast to change relative to photolithography and shadow masking

Referring again to FIG. 5B, the anode current collectors 142aa-dj at this stage may have area dimensions (i.e., length and width dimensions) that are 75-98% of the corresponding length and width dimensions, respectively, of the cells 150aa-dj. The pull-back distance of the ACCs 142aa-dj from the cell edges should be sufficient to electrically isolate the ACCs 140a-dfrom the CCC/substrate 100. In embodiments including a moat (see below), the edges of the ACCs 142aa-dj may be over the area(s) in which the moat is formed.

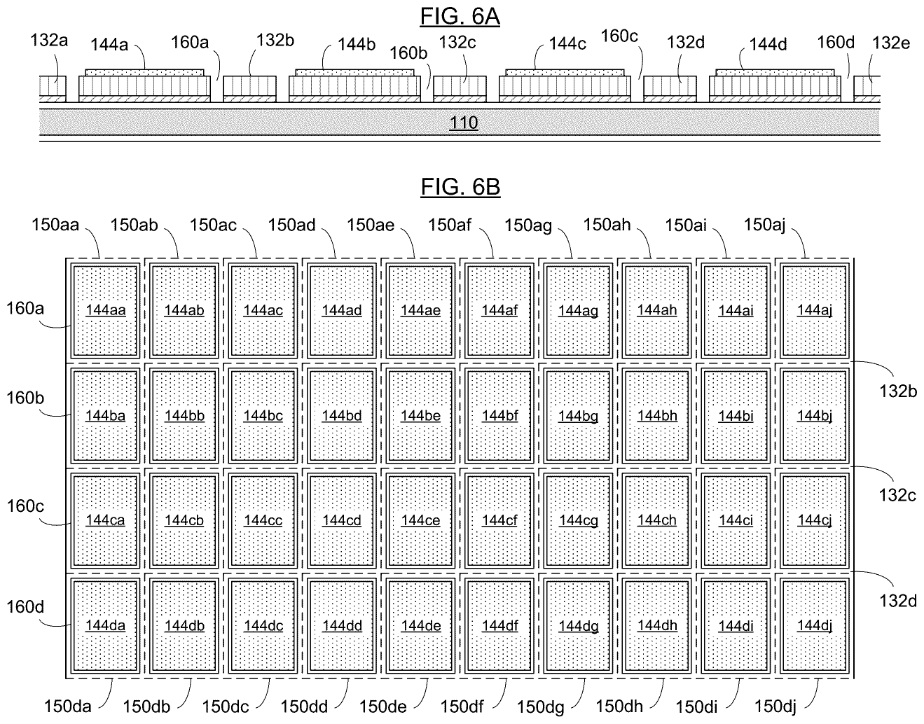

FIGS. 6A-10 show structures in a process for moat formation, ACC-edge electrical isolation and cell encapsulation, and formation of an interconnect/via and redistribution layer for contact with the anode current collectors 140. After battery layer fabrication and cell definition as described above, FIG. 6A shows the devices receiving a cut through the cathode 120 and the solid-state electrolyte 130 to form moats 160a-d that completely surround the respective ACCs 144a-d. To the extent that the ACCs 142a-d in FIGS. 5A-B extend into the area(s) in which the moats 160a-d are formed, the peripheries of the ACCs 142a-d may be trimmed, resulting in ACCs 144a-dwith outermost edges/borders that align with the innermost edges of the moats 160a-d. Optionally, the moats 160a-d may extend slightly into the substrate 100. In the present invention, however, the moats 160a-d and their formation are optional. The moats 160a-d are preferably formed by laser ablation or mechanical dicing, although they may also be low-resolution photolithographic patterning (e.g., of a photoresist or other mask material, using a photolithographic process with a minimum line width of 2 μm or more) and etching.

FIG. 6B shows a plan or top-down view of the substrate 110 with the ACCs 144aa-dj, moats 160a-d and exposed electrolyte 130 at the peripheries of the cells 150aa-dj. The moats 160a-d may have a width of 3-20 μm, although the invention is not limited to such widths. The moats 160a-d provide an anchoring feature for cell encapsulation (see the discussion below with regard to FIG. 8) and physically separate the active portion(s) of the battery layers from a peripheral/dummy region (e.g., defined by the moats 160a-d and the exposed electrolyte 130). When the moats 160a-d extend into the substrate 100, they fully isolate the active cathode and electrolyte layers 120 and 130. Each of these aspects of the moats 160a-d increases resistance to ambient ingress (e.g., of air and/or water vapor).

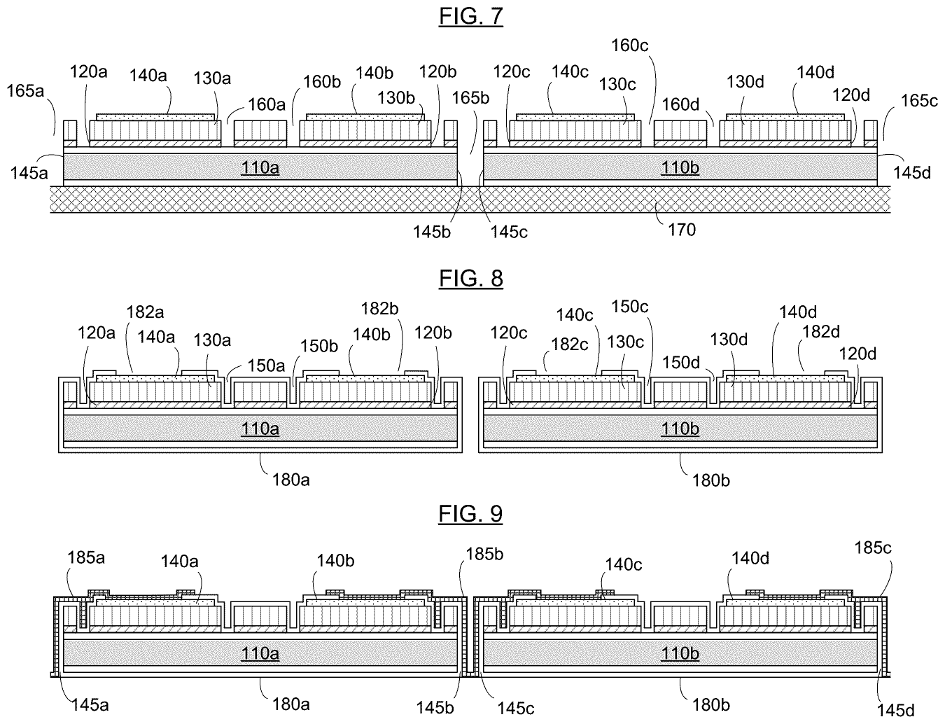

Referring to FIG. 7, the substrate 100 is attached to a substrate support or holder 170, and the electrolyte 130, the cathode 120 and the substrate 100 are cut or diced along the “ACC edges” 145a-d of the battery cells to form an opening 165a-c every other cell, or every other row or column of cells (when the cells are in an array or on a multi-column roll). This step is also optional in the present method. When the substrate support 170 is a tape or sheet, it is generally a UV release tape or sheet, containing an adhesive on one or both major surfaces that loses its adhesive properties upon sufficient irradiation with ultraviolet (UV) light. The tape or sheet may be on a ring or other frame, configured to mechanically support the tape or sheet and allow some tension therein and some light to pass through the underside of the tape or sheet. When the substrate support 170 is substrate holder (e.g., for cutting or dicing by stamping), it may comprise a magnetic plate or chuck.

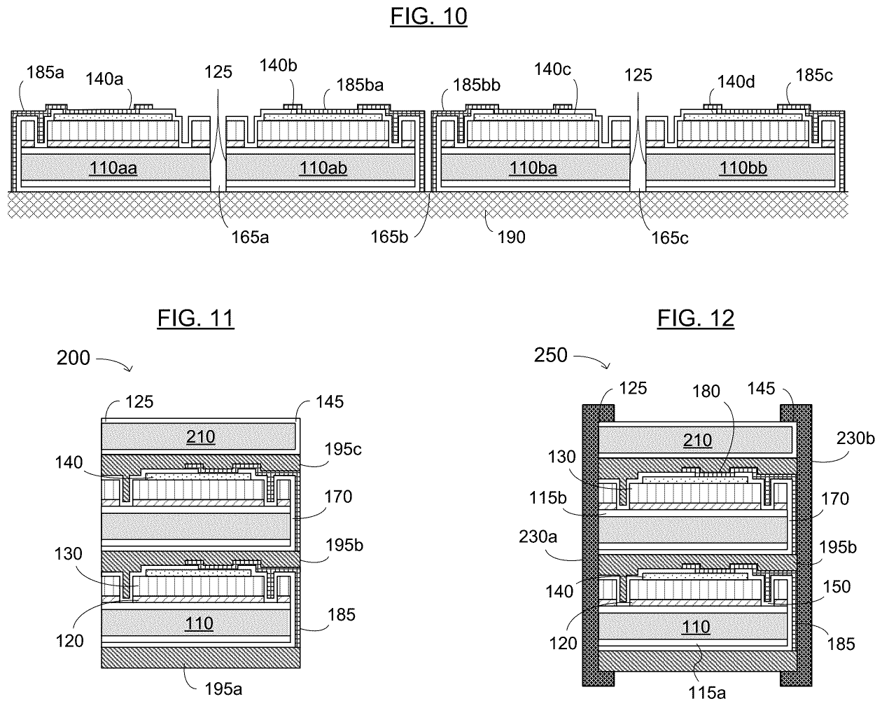

The ACC cell edges 145a-d are cut by laser (e.g., laser ablation), mechanical dicing or stamping, for example. When the cells are in an array or on a multi-column roll, they may also be cut or diced along the x-direction in FIG. 7 between adjacent cells (e.g., every column, or every row) to form isolated cell pairs. The sidewalls 145a-d along the cuts fully expose the entire cell stack, including the CCC/substrate 110. In a further option, the electrolyte 130, the cathode 120 and the substrate 100 between adjacent moats 150 not containing an ACC 140 are cut or diced (see, e.g., FIG. 10, which shows the further cuts resulting in “CCC edges” 125).

Referring now to FIG. 8, after the diced cell pairs (or strips of cell pairs) are released from the tape or sheet 170, the cell pairs are substantially encapsulated with a mechanically compliant moisture barrier and electrical insulation film 180a-b. The barrier/insulation film 180a-balso lines the inner surfaces of the moats 160a-d to provide further electrical isolation and moisture barriers to protect the battery cells. The barrier/insulation film 180a-b may cover the front or uppermost surface of the cells, the “ACC” side surface 145a-d of the cells, and optionally, the backside surface of the cells. The barrier/insulation film 180a-b is preferably printed (e.g., by inkjet printing or screen printing) onto the cells, but it may also be formed by coating (e.g., extrusion coating) or blanket deposition and patterning.

The barrier/insulation film 180a-b may comprise parylene, polyethylene, polypropylene, or another polyolefin, with or without a thin inorganic oxide overlayer such as SiO₂ (e.g., which may be formed by heating a tetraalkyl silicate such as tetraethyl orthosilicate [TEOS]). When printed, the material(s) of the barrier/insulation film 180a-b may be dissolved or suspended in an appropriate solvent (e.g., one or more organic solvents, such as a C₆-C₁₀ alkane or cycloalkane, a C₁-C₆ halogenated alkane or cycloalkane including one or more halogen atoms and that is in the liquid phase at 25° C. and 1 atm pressure, a C₄-C₆ cyclic or acyclic ether, a C₄-C₁₀ cyclic or acyclic polyether, a C₁-C₁₀ cyclic or acyclic alkanol, a C₃-C₄ ketone, a C₆-C₁₀ arene substituted with 1-3 C₁-C₄ alkyl groups,) prior to printing. In certain embodiments, after printing or deposition, the material for the barrier/insulation film 180a-b may be cured (c.g., by irradiation with ultraviolet light) to provide certain desirable properties (e.g., a certain minimum hardness, optical property, adhesion, etc.).

One advantage of printing to form the barrier/insulation film 180a-b is that an opening 182a-d may be formed on each cell over the ACC 140 during printing, without any need for additional processing (such as laser ablation, photolithographic patterning, etc.) to form the openings. Another advantage of printing is that, if further cuts resulting in “CCC edges” 125 are made, such edges can be selectively not covered with the barrier/insulation film 180a-b by simply not printing the barrier/insulation film 180a-b on those edges.

FIG. 9 shows formation of redistribution metal layers 185a-c along the ACC edges 145a-d and in vias or openings 182a-d in the barrier/insulation films 180a-b to connect the ACCs 140a-d to a subsequently formed external battery terminal. The redistribution layers 185a-c may comprise Cu, Ni, Al, or another suitable and/or stable (e.g., air-and/or water-stable, and/or lithium-compatible) metal, and may be formed by sputtering, ALD or thermal evaporation (e.g., through a mask that exposes a region of the cell corresponding to the pattern of the redistribution layers 185a-c, followed by removal of the mask, or by blanket deposition, followed by photolithographic patterning and etching), or by selective deposition, such as inkjet printing, aerosol-jet printing or screen printing. Printing may comprise use of a conventional metal-containing ink or paste. In some embodiments, the length and width dimensions of the redistribution layers 185a-c may be on the scale of hundreds of microns (e.g., 200-1000 μm) or several millimeters (e.g., 1-10 mm), thereby enabling selective deposition processes such as inkjet printing, screen printing and shadow masking.

Low electrical resistance and a low curing temperature is desirable for the redistribution layers 185a-c, and the redistribution layers 185a-c have a thickness typically in the range 0.25-2 μm on the uppermost surface of the cells. Due to liquid flow during printing, the entireties of the vias or openings 182a-d may be filled with metal, which may be beneficial during battery cycling.

A single redistribution layer (e.g., 185b) is on the ACC edges 145a-d of adjacent cells. The redistribution layers (or ACC redistribution traces) 185a-c go from the ACCs 140a-dexposed through the vias or openings 182a-d to the ACC edges 145a-d, in the opposite direction from the CCC edges 125 (FIG. 10).

The ACC redistribution traces 185a-c electrically contact the ACCs 140a-d through the vias 182a-d, but are physically and electrically insulated from the CCCs/substrates 110a-b by the barrier/insulation films 180a-b. When the ACC redistribution traces 185a-c are a metal, they form an intrinsic barrier to ambient ingress in the region of the vias or openings 182a-d. The ACC redistribution traces 185a-c are both physically on the top surface of the cell and covering at least part of the corresponding sidewalls 145a-d. The ACC redistribution traces 185a-c on the sidewalls 145a-d enable electrical connection to the cells through a terminal on the side of the battery at a later stage of the method.

In one embodiment, the method comprises printing both the insulator for the barrier/insulation film 180a-b and the metal for the redistribution layer 185a-c, using dual (separate) inkjet printer heads. Preferably, the materials for the barrier/insulation film 180a-b and the ACC redistribution traces 185a-c are printed separately, with an optional curing step between the separate printing steps, if necessary or desired, although they may be printed simultaneously in some cases (e.g., where the solvents for the different layers are immiscible). This allows for faster cycle times and more efficient use of capital for manufacturing equipment.

In further embodiments involving printing the barrier/insulation film 180a-b and the redistribution layer 185a-c, prior to printing either or both layers, the method may further comprise testing the cells to determine battery functionality (e.g., charging, charge holding, and/or discharging properties). Cells that fail testing (i.e., that are identified as non-functional or insufficiently functional) may have the barrier/insulation film 180a-b and/or the redistribution layer 185a-c printed differently. For example, if the cells are tested prior to printing the barrier/insulation film 180a-b, the via/opening in the barrier/insulation film 180a-b can be omitted in those cells that fail testing. In other words, when a cell fails testing (i.e., is identified as defective) prior to printing the barrier/insulation film 180a-b, the barrier/insulation film 180a-b may completely cover the ACC layers 140a-d in the defective cell. Similarly, when a cell fails testing prior to printing the redistribution layer 185a-c, the redistribution layer 185a-c may be omitted (i.e., not printed) in those defective cells.

FIG. 10 shows singulated cells on substrates 110aa, 110ab, 110ba and 110bb. Prior to singulation (dicing), the cell pairs may be placed on a substrate holder (e.g., a magnetic plate or chuck) or an epoxy-coated tape 190. In this case, dicing along the CCC edges 125 (to form openings 165a-c) creates the single cells. Alternatively, dicing along the CCC edges 125 can be performed at the same time as dicing along the ACC edges 145 (FIG. 7), in which case the barrier/insulation film 180a-b and the redistribution layer 185a-c should be printed (to avoid depositing the film 180a-b and the layer 185a-c on the CCC edges 125). The epoxy coating (not shown) on the tape 190 holds the cells together during stacking (FIG. 10), and may provide a passivation/scaling layer on one side or surface of the stacked cells during packaging. Thus, the coated tape 190 may comprise a die attach film (DAF). Alternatively, an adhesive (c.g., an epoxy adhesive) may be coated or printed onto the upper or lower surface of the battery cells.

Singulation may be conducted by laser dicing, but mechanical dicing and stamping are also possible. Thus, the epoxy coating may also be cut during singulation, as may the tape 190. The redistribution layer 185b (FIG. 8) may be cut or separated to form redistribution layers 185ba and 185bb either during singulation or during removal (e.g., from a chuck or other deposition/patterning apparatus) at or near the end of the redistribution layer formation process.

As shown in FIG. 11, after removal of the cells from the tape 190, stacking forms a multi-layer set of parallel cells 200 with the CCC (substrate) edges 125 along one side of the stack, and the ACC edges 145a-d (including the ACC trace/redistribution layers 185) along the opposite side. The epoxy adhesion 195b-c between cells can be from the coated tape 190 (FIG. 10) or from a liquid die attach (DA) or printing process, and can be applied to the back and/or front major surface of the cells, prior to or after cell singulation. If not applied as part of a DA process, the epoxy 195a-c can be applied by methods such as b-stage laminated film formation, dispensing, jetting, inkjet printing, screen printing, etc. The stacked set of cells 200 forms a stacked solid-state battery. The parallel cells each additively contribute to the overall battery capacity.

Cell stacking may comprise a conventional pick-and-place technique. However, other stacking methods, such as strip folding, strip stacking, etc. (see, e.g., U.S. patent application Ser. No. 17/185, 122, filed Feb. 25, 2021 [Attorney Docket No. IDR2020-02], the relevant portions of which are incorporated herein by reference), before or after dicing are also acceptable. A dummy cell 210 (e.g., an encapsulated metal foil substrate 110 or 110/115, for example as described with respect to FIG. 8) may be placed on top of the stack 200 as a moisture and air barrier and to protect the stack 200 from externally-caused damage. Optionally, markings on one major surface of the dummy cell 210 can be used as external product markings.

Alternatively, sheets or rolls of cells (as described herein) may be stacked or layered and secured to each other, and the stacked/layered sheets or rolls of cells singulated thereafter. For example, a layer of adhesive (e.g., an epoxy) can be blanket-deposited onto individual sheets or rolls of cells, or selectively deposited onto or applied to individual cells, or rows or columns thereof, then multiple sheets or rolls of cells can be stacked and aligned (e.g., using alignment marks such as notches along the outer edges of the sheets or rolls). The adhesive can be secured to an adjacent sheet or roll using pressure, then activated with additional pressure, ultraviolet radiation, or a chemical activator (which may be applied to the facing surface of the adjacent sheet or roll). Singulation of the stacked sheets or rolls can be conducted as described herein for a single sheet or roll of cells.

Battery terminal dipping and plating the stacked set of cells 200 forms external electrical contacts 230a-b, as shown in FIG. 12. End terminals at the CCC and ACC edges 125 and 145 (e.g., the exposed edges of the CCCs 110 and the redistribution layers 185, respectively) are dipped into or coated with a conductive epoxy to electrically gang the terminals and form the CCC terminal 230a and ACC terminal 230b of the packaged battery. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating a metal onto part or all of the CCC terminal 230a and ACC terminal 230b creates a solderable surface for PCB attachment by the end user. For solderable termination, the epoxy surface may be plated with Ni, Ag, In, Sn, or a combination thereof (e.g., Ni, then with In or Sn).

In some embodiments, the conductive epoxy 230a-b contains a relatively high metal content, which can retard ambient ingress (e.g., of oxygen or water vapor). The epoxy 230a-b may be plated with one or more pure metal layers, to further block ambient ingress. Both of these features help with ambient air resistance, particularly on the CCC edge 125, due to the barrier/insulation film 180 being diced at this edge during cell singulation from the cell pairs (FIG. 10).

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A method of making solid-state battery cells, comprising:
blanket-depositing a cathode material, a solid-state electrolyte, and an anode current collector (ACC) material on a substrate;
laser-patterning the ACC material to define the solid-state battery cells and form an ACC in each of the cells; and
cutting or dicing the solid-state battery cells through the electrolyte and the cathode material to form a cathode in each of the solid-state battery cells.

2. The method of claim 1, wherein the ACC material is laser-patterned using a programmable laser patterning device, and the method further comprises programming the programmable laser patterning device.

3. The method of claim 2, wherein the programmable laser patterning device is programmed to form polylines in the ACC material, the polylines comprising a first plurality of parallel lines along a first direction and a second plurality of parallel lines along a second direction, such that the first and second pluralities of parallel lines do not form sharp corners.

4. The method of claim 1, wherein the ACC material is laser-patterned using light having a wavelength of 240-1400 nm, a pulse length of 5 femtoseconds to 1000 ns, a pulse frequency of 105-1014 Hz, and a power of 10-1000 W.

5. The method of claim 1, further comprising forming a moat in each of the laser-patterned battery cells prior to cutting or dicing the battery cells.

6. The method of claim 1, wherein cutting or dicing the battery cells comprises cutting or dicing the battery cells through the substrate every other cell to form ACC edges or sidewalls of the battery cells.

7. The method of claim 1, further comprising, after cutting or dicing the battery cells, encapsulating each of the battery cells with an encapsulant, including along the ACC edges or sidewalls, and forming or leaving an opening in the encapsulant exposing the ACC.

8. The method of claim 7, wherein the encapsulant comprises a moisture barrier and electrical insulation film.

9. The method of claim 7, further comprising forming a redistribution layer on the exposed ACC and the encapsulant, including along the ACC edge or sidewall.

10. The method of claim 9, wherein the redistribution layer comprises an elemental metal or an alloy thereof.

11. The method of claim 1, further comprising singulating the battery cells.

12. The method of claim 11, wherein cutting or dicing the battery cells forms dual cells or dual rows or columns of cells having exposed ACC edges or sidewalls of the battery cells, and singulating the encapsulated battery cells comprises cutting or dicing the dual cells or dual rows or columns of cells through the substrate to form CCC edges or sidewalls of the battery cells.

13. The method of claim 11, further comprising stacking and/or packaging the singulated battery cells.

14. The method of claim 13, comprising stacking the singulated battery cells and packaging the stacked battery cells, wherein the stacked battery cells have all of the ACC edges or sidewalls on a first side of the stacked battery cells and all of the CCC edges or sidewalls on a second side of the stacked battery cells.

15. The method of claim 1, wherein the cathode material comprises a lithium metal oxide or lithium metal phosphate.

16. The method of claim 1, wherein the solid-state electrolyte comprises lithium phosphorus oxynitride (LiPON), carbon-doped LiPON, or Li₂WO₄.

17. The method of claim 1, wherein the ACC material comprises a conductive metal or graphite.

18. The method of claim 1, wherein the substrate comprises a metal foil having a thickness of 10-100 μm.

19. The method of claim 18, wherein the substrate comprises a stainless steel foil.

20. The method of claim 18, further comprising forming a diffusion barrier on the metal foil prior to blanket-depositing the cathode material.
